(19) United States
(12) Patent Application Publication
(10) Pub. No.: US 2007/0137024 A1
(43) Pub. Date: Jun. 21, 2007

(54) Method and system for testing a slider for a head gimbal assembly of a disk drive device

(75) Inventors: MingGao Yao, DongGuan (CN); Masashi Shiraishi, HongKong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/304,629

(22) Filed: Dec. 16, 2005

(51) Int. Cl. G11B 5/127

(52) U.S. Cl. 29/603.03; 29/603.1; 29/603.12; 360/122

(57) ABSTRACT

A method for building a slider into a product includes removably mounting a slider onto a test head suspension assembly, and conducting a dynamic performance test of the slider before the slider is built into the product.

### FIELD OF THE INVENTION

The present invention relates to information recording disk drive devices and, more particularly, to a method and system for testing a slider for a head gimbal assembly (HGA) of the disk drive device. More specifically, the present invention is directed to a dynamic performance testing method and system of testing a slider before manufacturing the head gimbal assembly or head stack assembly of the disk drive device.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate a micro-actuator are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803, entitled “Micro-actuator and HGA” and JP 2002-074871, entitled “Head Gimbal Assembly Equipped with Actuator for Fine Position, Disk Drive Equipped with Head Gimbals Assembly, and Manufacture Method for Head Gimbal Assembly.”

FIG. 1 illustrates a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider 103 incorporating a read/write head. A voice-coil motor (VCM) is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write head, and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

FIG. 2 illustrates the head gimbal assembly (HGA) 100 of the conventional disk drive device of FIG. 1 incorporating a dual-stage actuator. However, because of the inherent tolerances of the VCM and the head suspension assembly, the slider 103 cannot achieve quick and fine position control which adversely impacts the ability of the read/write head to accurately read data from and write data to the disk. As a result, a PZT micro-actuator 105, as described above, is provided in order to improve the positional control of the slider and the read/write head. More particularly, the PZT micro-actuator 105 corrects the displacement of the slider 103 on a much smaller scale, as compared to the VCM, in order to compensate for the resonance tolerance of the VCM and/or head suspension assembly. The micro-actuator 105 enables, for example, the use of a smaller recording track pitch, and can increase the “tracks-per-inch” (TPI) value by 50% for the disk drive unit, as well as provide an advantageous reduction in the head seeking and settling time. Thus, the PZT micro-actuator 105 enables the disk drive device to have a significant increase in the surface recording density of the information storage disks used therein.

Referring more particularly to FIGS. 3 and 4, a conventional PZT micro-actuator 105 includes a ceramic U-shaped frame which has two ceramic beams or side arms 107 each having a PZT element 116 attached thereto. The ceramic beams 107 hold the slider 103 therebetween and displace the slider 103 by movement of the ceramic beams 107 through excitation of the PZT elements 116. As illustrated, the slider 103 is partially bonded with the two ceramic beams 107 at two predetermined positions 106 by epoxy. This bonding makes the movement of the slider 103 dependent on the movement of the ceramic beams 107 of the micro-actuator 105 and independent of the motor arm 104.

The PZT micro-actuator 105 is physically coupled to a flexure 114 of suspension 113. Three electrical connection balls 109 (gold ball bonding or solder ball bonding, GBB or SBB) are provided to couple the micro-actuator 105 to the suspension traces 110 located at the side of each of the ceramic beams 107. In addition, there are four metal balls 108 (GBB or SBB) for coupling the slider 103 to the traces 110. When power is supplied through the suspension traces 110, the PZT elements 116 expand or contract to cause the two ceramic beams 107 of the U-shape micro-actuator frame to deform, thereby making the slider 103 move on the track of the disk in order to fine tune the position of the read/write head. In this manner, controlled displacement of slider 103 can be achieved for fine positional tuning.

To keep the slider 103 moving smoothly when the PZT elements 116 deform, a parallel gap 120 is provided between the back side of the slider 103 and the suspension tongue 122 of the suspension. A dimple 124 in the suspension load beam 126 of the suspension is provided to transfer force between the suspension load beam 126 and the suspension tongue 122.

The manufacture of a micro-actuator HGA (such as the embodiment described above) is relatively expensive in comparison to a traditional HGA due to the additional micro-actuator component, e.g., 10-50% higher cost. When a HGA is manufactured and a component is found to be defective, the entire HGA is scrapped. That is, no matter which component of the HGA is defective, such as the suspension, head slider, and/or micro-actuator, all the parts will be scrapped. This becomes expensive for the manufacturer, especially for micro-actuator HGAs.

As is known in the art, the head slider presents the main challenge due to the high area density HDD application. First, the manufacture of the head wafer is very difficult since the head sensor track width becomes narrower and narrower. Also, the stability is very important for the high density HDD. Due to various limitations, a defect cannot be prevented without manufacturing the head slider and testing the same. This practice provides immense pressure and difficulty to the industry.

A second challenge relates to the head slider manufacture. The current manufacturing process for the head slider is very complex and every process needs a very accurate control. Due to the manufacturing process limitations, a defect cannot be prevented before testing the slider head. Even with limited static testing, the actual slider head performance may still be poor. This means that a dynamic performance test is needed before the manufacture of the head gimbal assembly or head stack assembly. Otherwise, the suspension and micro-actuator of the HGA may be scrapped due to poor performance of the slider head built into the head gimbal assembly. On the other hand, even if a limited rework process is performed, the poor yield for the rework process is expensive which will increase the unit prices of the HDD application.

As noted above, it is known to perform static testing to test the slider head performance during the slider manufacturing process. However, this testing is still limited and cannot 100% screen out all defective slider heads. Thus, dynamic testing of the slider is performed at the HGA level and the entire HGA is scrapped if the slider is defective. This practice is why a lot of component material is wasted at the HGA level due to a poor slider head.

Thus, there is a need for an improved method and system for testing a slider for use in head gimbal assemblies and disk drive units that does not suffer from the above-mentioned drawbacks.

### SUMMARY OF THE INVENTION

One aspect of the present invention relates to a method and system for dynamically testing a slider for a head gimbal assembly before the slider is mounted to the head gimbal assembly.

Another aspect of the invention relates to a method for building a slider into a product. The method includes removably mounting a slider onto a test head suspension assembly, and conducting a dynamic performance test of the slider before the slider is built into the product.

Yet another aspect of the invention relates to a method for testing the dynamic performance of a slider. The method includes providing a slider to be tested, removably mounting the slider to a test head suspension assembly, loading the test head suspension assembly to a dynamic testing system, testing the dynamic performance of the slider, detaching the slider from the test head suspension assembly, and mounting the slider to a HGA based on testing results from the dynamic performance testing of the slider.

Still another aspect of the invention relates to a test head suspension assembly for testing the dynamic performance of a slider. The test head suspension assembly includes a suspension and a support structure connected to the suspension. The support structure is structured to removably support a slider to be tested on the suspension.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a partial perspective view of a conventional disk drive unit;

FIG. 2 is a perspective view of a conventional head gimbal assembly (HGA);

FIG. 3 is a perspective view of a slider and PZT micro-actuator of the HGA shown in FIG. 2;

FIG. 4 is a partial side view of the HGA shown in FIG. 2;

FIG. 5 is a perspective view of a test head suspension assembly according to an embodiment of the present invention;

FIG. 6 is a perspective of a suspension of the test head suspension assembly shown in FIG. 5;

FIG. 7 is an exploded view of the suspension shown in FIG. 6;

FIG. 8 is a perspective view of an embodiment of a support structure of the test head suspension assembly shown in FIG. 5;

FIG. 9 is a partial front perspective view of the test head suspension assembly shown in FIG. 5;

FIG. 10 is a partial rear perspective view of the test head suspension assembly shown in FIG. 5;

FIG. 11 is a partial side view of the test head suspension assembly shown in FIG. 5;

FIG. 12 is a perspective view of another embodiment of a support structure for the test head suspension assembly shown in FIG. 5;

FIG. 13a-13j are sequential views illustrating a slider testing process according to an embodiment of the present invention;

FIG. 14 is a flow chart illustrating a slider testing process according to an embodiment of the present invention;

FIG. 15 is a flow chart illustrating a manufacturing process according to an embodiment of the present invention;

FIG. 16 is a perspective view of a test head suspension assembly according to another embodiment of the present invention;

FIG. 17 is a partial front perspective view of the test head suspension assembly shown in FIG. 16;

FIG. 18 is a partial rear perspective view of the test head suspension assembly shown in FIG. 16;

FIG. 19 is a partial side view of the test head suspension assembly shown in FIG. 16;

FIG. 20 is a perspective view of a support structure for a test head suspension assembly according to another embodiment of the present invention;

FIG. 21 is a side view of the support structure and the test head suspension assembly of FIG. 20;

FIG. 22 is a partial rear perspective view of a test head suspension assembly according to another embodiment of the present invention;

FIG. 23 is a partial side view of the test head suspension assembly shown in FIG. 22;

FIG. 24 is a partial front perspective view of a test head suspension assembly according to another embodiment of the present invention, the test head suspension assembly receiving a slider to be tested;

FIG. 25 is a partial front perspective view of the test head suspension assembly shown in FIG. 24 with the slider removably mounted to the test head suspension assembly;

FIG. 26 is a side view of the test head suspension assembly and slider shown in FIG. 25;

FIG. 27 is a partial front perspective view of a test head suspension assembly according to yet another embodiment of the present invention, the test head suspension assembly receiving a slider to be tested;

FIG. 28 is a partial front perspective view of the test head suspension assembly shown in FIG. 27 with the slider removably mounted to the test head suspension assembly; and

FIG. 29 is a side view of the test head suspension assembly and slider shown in FIG. 28.

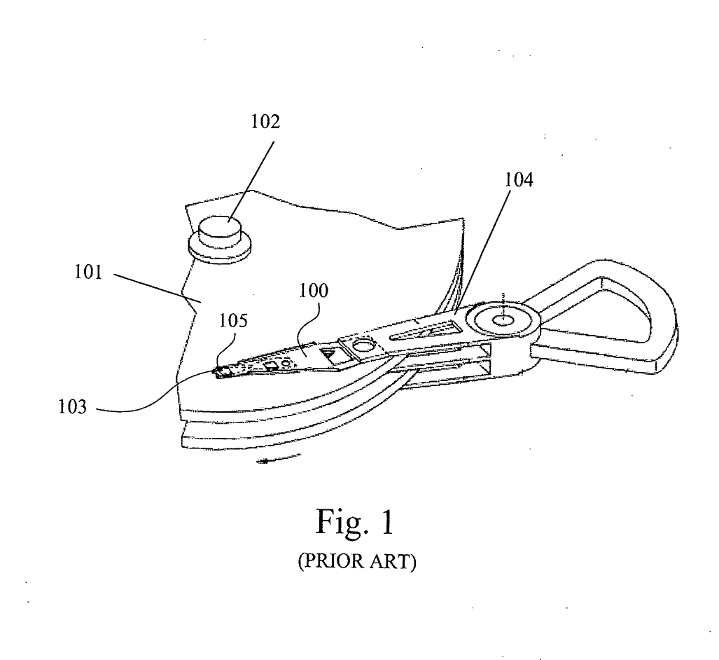

### DETAILED DESCRIPTION OF ILLUSTRATED EMBODIMENTS

Various preferred embodiments of the instant invention will now be described with reference to the figures, wherein like reference numerals designate similar parts throughout the various views. As indicated above, the instant invention is designed to reduce manufacturing costs for manufacturing a head gimbal assembly (HGA). An aspect of the instant invention is to provide a method and system for dynamically testing a slider for a head gimbal assembly before the slider is mounted to the head gimbal assembly. By dynamically testing the slider before the slider is mounted to the head gimbal assembly, a defective slider can be individually scrapped rather than the entire HGA.

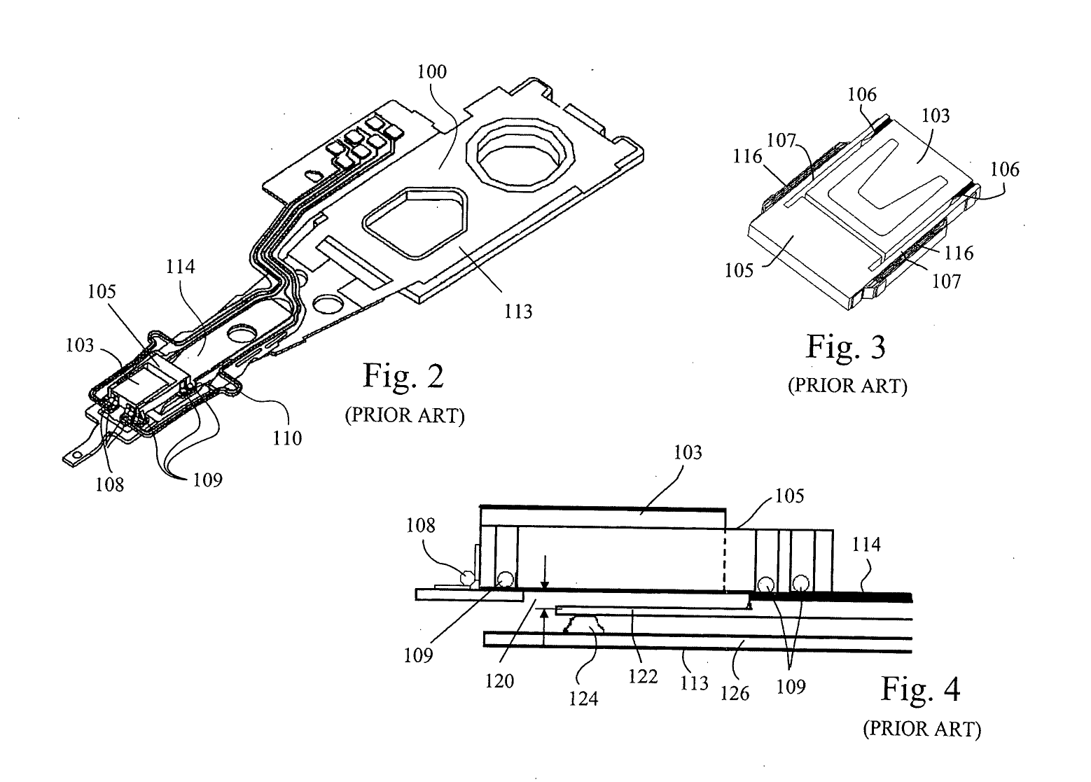

Several example embodiments of systems and methods for testing a slider before the slider is mounted to a HGA will now be described. Some of the example embodiments are illustrated in the figures and described as being implemented in a head gimbal assembly (HGA) of the type described above in connection with FIGS. 2-4. However, it is noted that the invention is not limited to such implementations. Instead, the systems and methods for testing a slider before the slider is mounted to a HGA may be implemented in any suitable device having a slider in which it is desired to test, regardless of the specific structure of the slider or HGA illustrated in the figures. That is, the invention may be used in any suitable device having a slider in any industry.

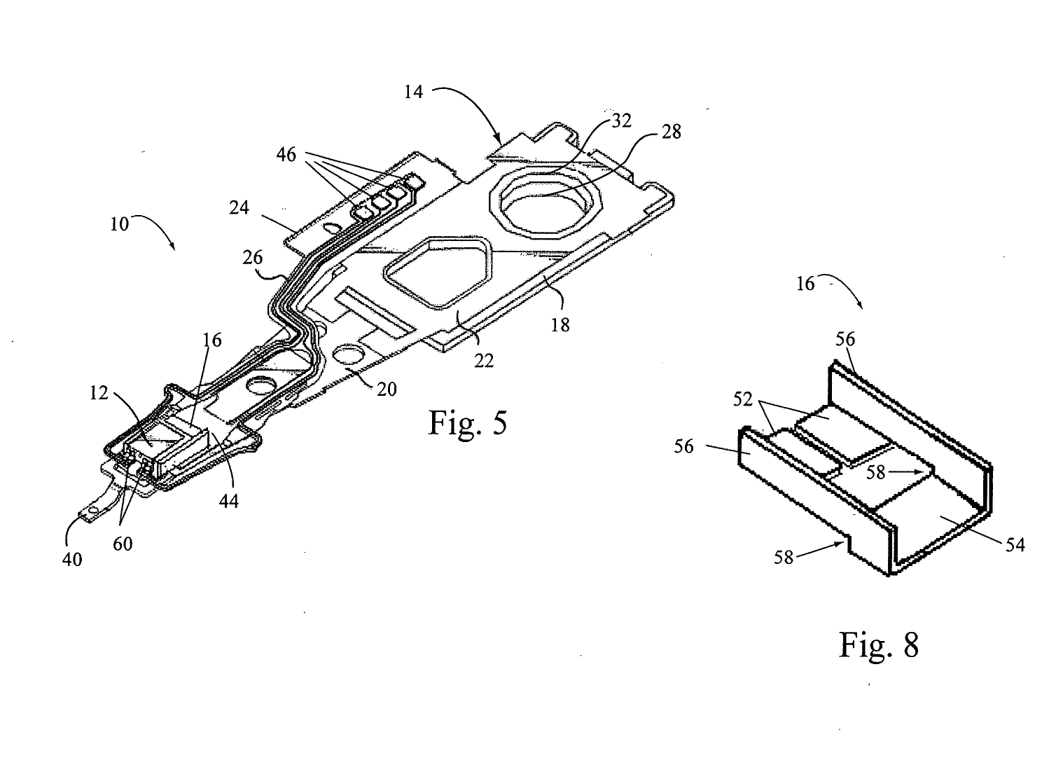

FIG. 5 illustrates a test head suspension assembly 10 according to a first exemplary embodiment of the present invention. As described in greater detail below, a slider 12 is removably mounted to the test head suspension assembly 10 so that dynamic performance testing can be preformed on the slider 12 before the slider 12 is mounted to a HGA of a disk drive device. If the slider 12 is not defective based on the testing, the non-defective slider 12 can then be mounted to the HGA. This process allows defective sliders to be scrapped rather than an entire HGA. As a result, this process greatly improves the process yield and also greatly reduces manufacturing costs.

As shown in FIG. 5, the test head suspension assembly 10 (also referred to as a test head gimbal assembly (test HGA)) includes a suspension 14 and a support structure 16 to support a slider 12 to be tested.

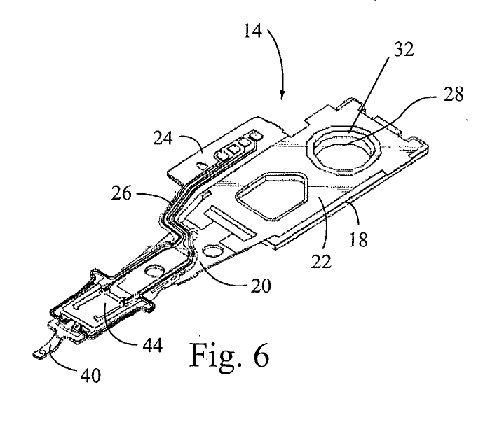

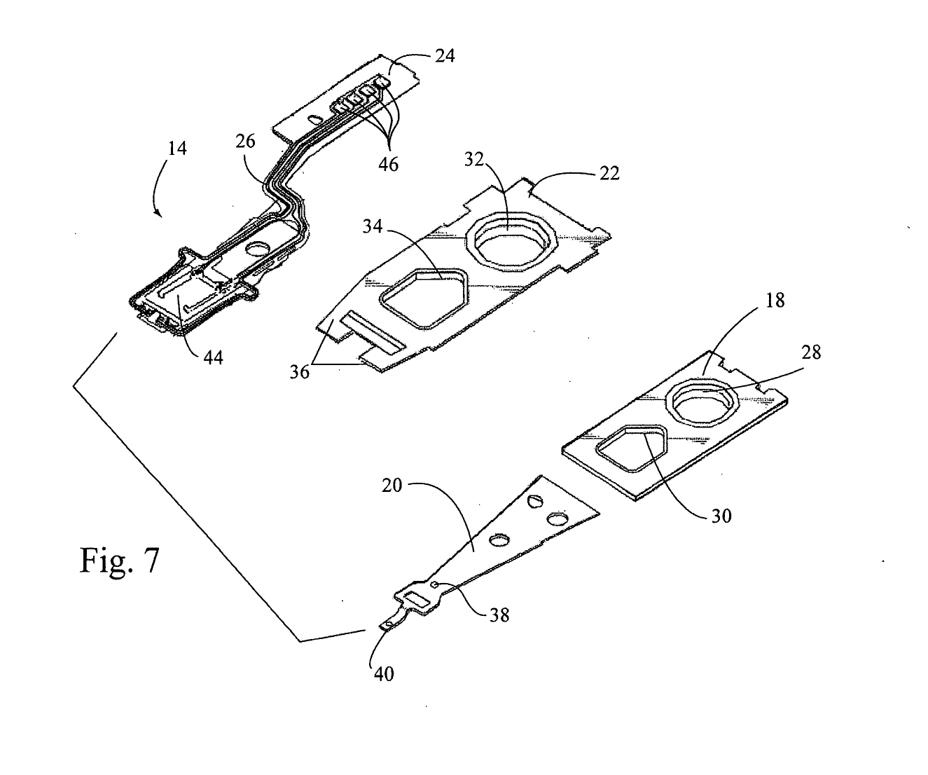

As best shown in FIGS. 5-7, the suspension 14 includes a base plate 18, a load beam 20, a hinge 22, a flexure 24, and a suspension trace 26 in the flexure 24. The base plate 18 includes a mounting hole 28 for use in connecting the suspension 14 to a test carriage of a dynamic testing system. The base plate 18 also includes a hole 30 for reducing weight. The shape of the base plate 18 may vary depending on the configuration of the test carriage. Also, the base plate 18 is constructed of a relatively hard or rigid material, e.g., metal, to stably support the suspension 14 on the test carriage.

The hinge 22 is mounted onto the base plate 18, e.g., by welding. As illustrated, the hinge 22 includes holes 32, 34 that align with the holes 28, 30 provided in the base plate 18. Also, the hinge 22 includes two holder bars 36 for supporting the load beam 20.

The load beam 20 is mounted onto the two holder bars 36 of the hinge 22, e.g., by welding. The load beam 20 has a dimple 38 formed thereon for engaging the flexure 24. An optional lift tab 40 may be provided on the load beam 20 to lift the test head suspension assembly 10 from the disk when the disk is not rotated. Also, a limiter 42 may be provided on the load beam 20 to limit the movement or deformation of a suspension tongue 44 (see FIG. 10).

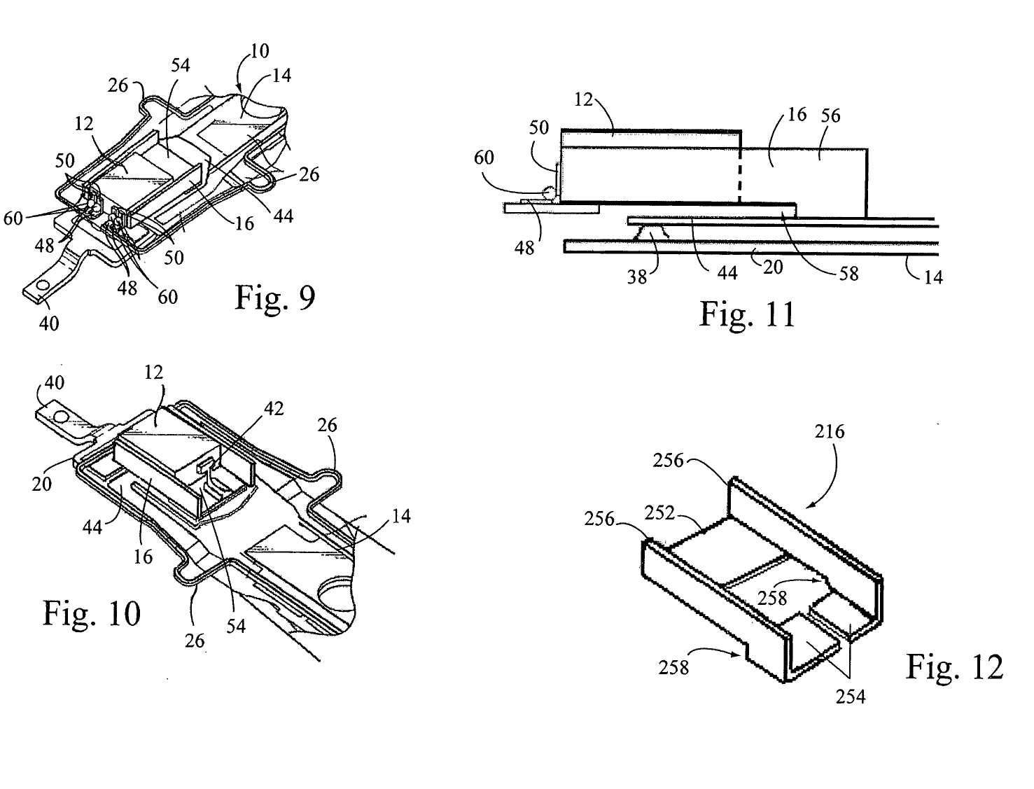

The flexure 24 is mounted to the hinge 22, e.g., by welding. The flexure 24 is provides a suspension tongue 44 to couple the support structure 16 to the suspension 14. Also, the suspension trace 26 is provided on the flexure 24 to electrically connect a plurality of bonding pads 46 (which connect to a test fixture of a dynamic testing system) with a slider to be tested. The suspension trace 26 may be a flexible printed circuit (FPC) and may include any suitable number of lines. As best shown in FIGS. 9 and 11, bonding pads 48 are directly connected to the suspension trace 26 to electrically connect the suspension trace 26 with bonding pads 50 provided on a slider 12 to be tested.

FIG. 8 illustrates the support structure 16 removed from the suspension 14. As illustrated, the support structure 16 includes a top arm 52, a bottom arm 54, and support beams 56 that interconnect the top arm 52 and bottom arm 54. The support structure 16 may be formed by forming the support beams 56 on both sides of the support structure 16 in a one step, and separating the top arm 52 into two parts in another step. The two step forming provides a parallel gap 58, e.g., in the range of about 30˜100 um, between the top arm 52 and the bottom arm 54. The support structure 16 may be made of metal or other suitable stiff material, e.g., ceramic, polymide, polymer, or rubber.

As best shown in FIGS. 9-11, the bottom arm 54 is structured to connect the support structure 16 to the suspension 14. Specifically, the bottom arm 54 is mounted to the suspension tongue 44 of the flexure 24, e.g., by epoxy, resin, or welding by laser.

The top arm 52 is structured to removably support a slider 12 to be tested on the suspension 14. Specifically, a slider 12 to be tested is detachably mounted to the top arm 52 by a mounting material such as water dissolved resin or adhesive. These materials allow the slider 12 to be detached from the support structure 16 when testing of the slider 12 has been completed. However, other suitable mounting materials may be used, e.g., epoxy, ACF, resin.

After the slider 12 is detachably mounted to the support structure 16, the slider 12 is then electrically connected to the suspension trace 26. Specifically, the slider 12 has multiple bonding pads 50, e.g., four bonding pads, on an end thereof corresponding to the bonding pads 48 of the suspension 14. The bonding pads 48 of the suspension 14 are electrically bonded with respective pads 50 provided on the slider 12 using, for example, electric connection balls 60 (GBB or SBB) or solder paste. This electrically connects the slider 12 and its read/write elements to the bonding pads 46 associated with the test fixture.

FIG. 12 illustrates another embodiment of a support structure 216 for use on the suspension 14. In this embodiment, the support structure 216 is formed such that the bottom arm 254 is separated into two parts. Similar to the support structure 16, the support structure 216 may be formed by forming the support beams 256 on both sides of the support structure 216 in a one step, and separating the bottom arm 254 into two parts in another step. The two step forming provides a parallel gap 258 between the top arm 252 and the bottom arm 254.

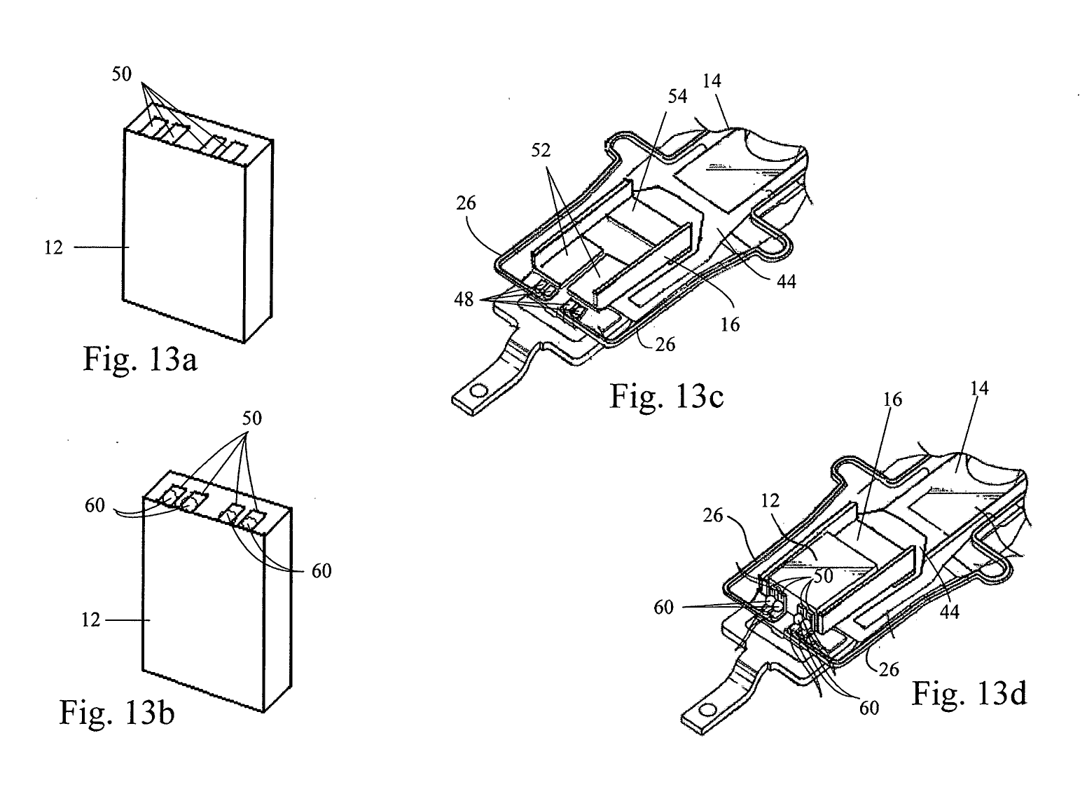

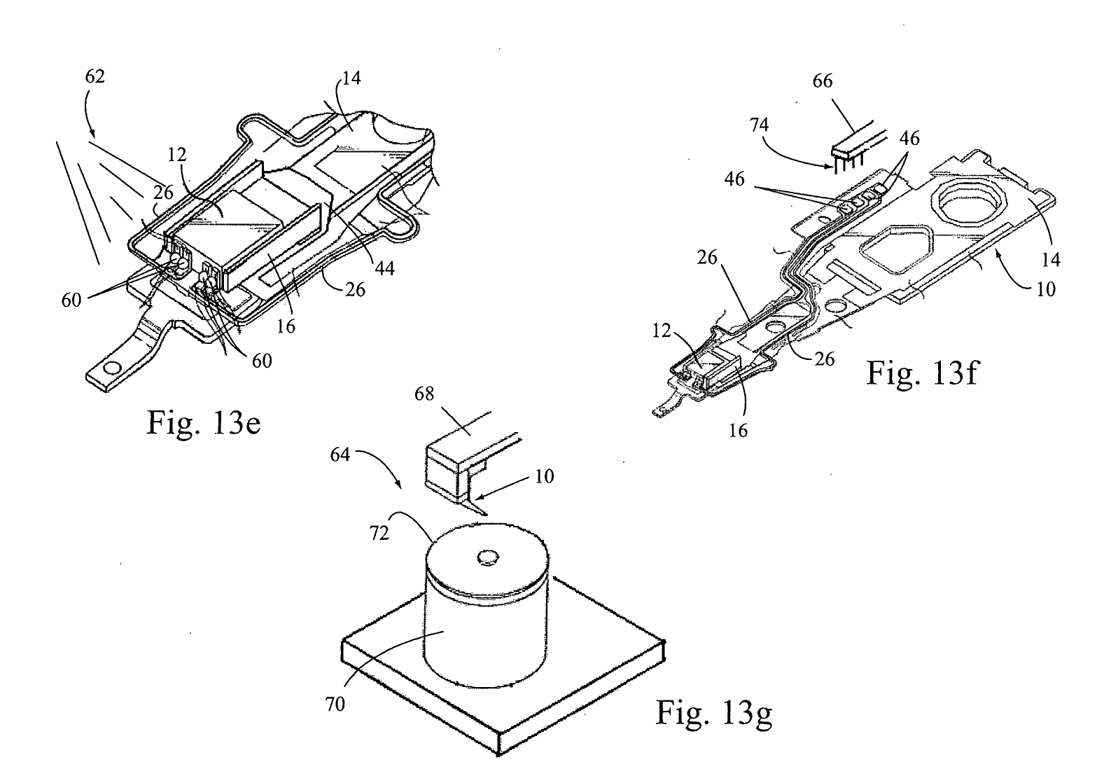

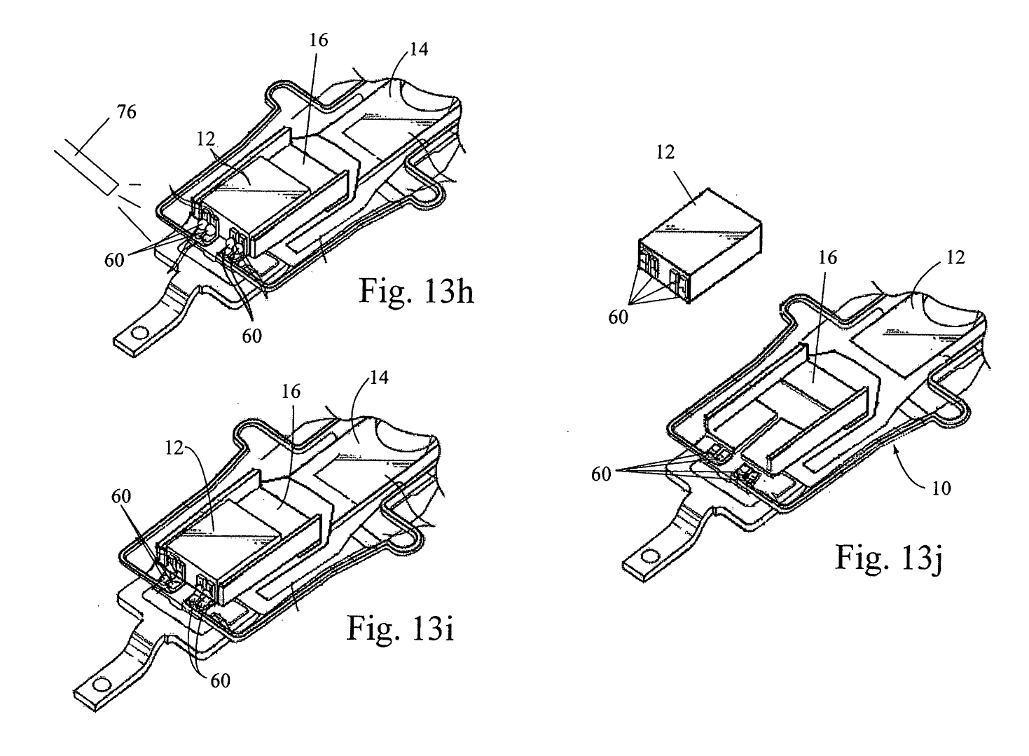

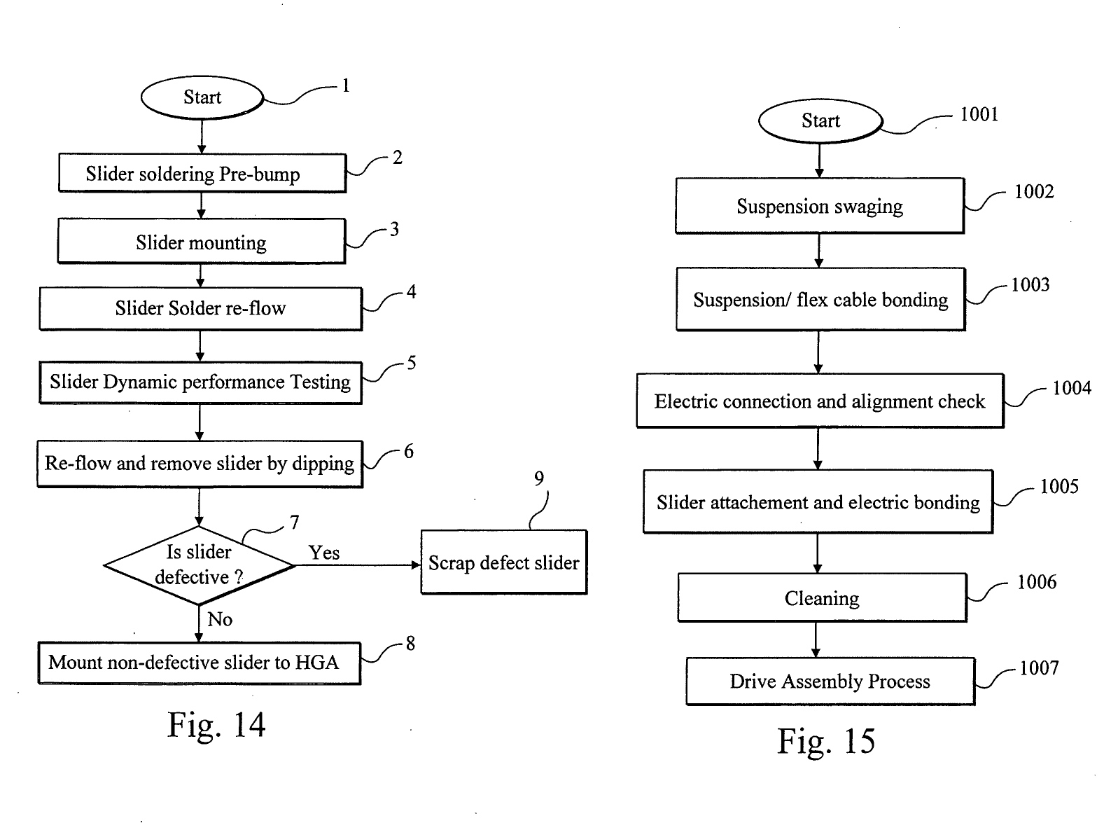

FIGS. 13a-13j and 14 illustrate the primary steps involved in the testing process of a slider 12 to be incorporated into a head gimbal assembly according to a first exemplary embodiment of the present invention. Specifically, after the process starts (step 1 of FIG. 14), a test slider 12 (having four bonding pads 50 as shown in FIG. 13a) is provided with four solder balls 60 in a solder pre-bump process. That is, four solder balls 60 are pre-bumped or attached, e.g., by laser or heat, to respective bonding pads 50 on the slider 12 (step 2 of FIG. 14), as shown in FIG. 13b.

Then, the pre-bumped test slider 12 is mounted to the test head suspension assembly 10. As explained above, the test head suspension assembly 10 includes a support structure 16 having a top arm 52 for supporting the test slider 12 that is spaced from the suspension tongue 44 of the suspension 14 as shown in FIG. 13c. Also, bonding pads 48 connected to the suspension trace 26 are provided adjacent the top arm 52 for electrically connecting the suspension trace 26 with the test slider 12.

As shown in FIG. 13d, the pre-bumped test slider 12 is detachably mounted to the top arm 52 by water dissolved resin or adhesive (step 3 of FIG. 14). This positions the electric connection balls 60 provided on the slider 12 into engagement with the bonding pads 48 on the suspension 14.

Then, as shown in FIG. 13e, a re-flow process is applied to the slider 12 and suspension 14 to cure the electric connection balls 60 so as to electrically connect the bonding pads 50 of the test slider 12 with the bonding pads 48 of the suspension 14 (step 4 of FIG. 14). In the illustrated embodiment, a laser re-flow process is performed wherein a laser 62 is used to cure and melt the electric connection balls 60 so as to electrically connect the slider bonding pads 50 and the suspension bonding pads 48. Once the test slider 12 is physically and electrically coupled to the test head suspension assembly 10, the test head suspension assembly 10 may be coupled to a dynamic testing system that does dynamic performance testing on the test slider 12 to determine if the test slider 12 is defective.

As shown in FIGS. 13f and 13g, the dynamic testing system 64 includes a test fixture 66, a test carriage 68, and a spindle motor 70 that rotates a single storage disk 72. The test fixture 66 includes multiple probe pins 74, e.g., four probe pins, that are electrically engaged with respective bonding pads 46 provided on the test head suspension assembly 10. This electrically connects the test fixture 66 to the slider 12 and its read/write elements via the suspension trace 26.

The test carriage 68 is structured to mount the test head suspension assembly 10 to the dynamic testing system 64. Specifically, the suspension 14 of the test head suspension assembly 10 is mounted to the test carriage 68 (e.g., via the mounting holes 28, 32 provided in the base plate 18 and the hinge 22 of the suspension 14. Once the test head suspension assembly 10 and its test slider 12 is mounted to the dynamic testing system 64, dynamic performance testing (step 5 of FIG. 14) may be performed on the test slider 12.

As shown in FIG. 13g, the test carriage 68 controllably moves the test head suspension assembly 10 to position the test slider 12, and associated read/write elements, over the rotating disk 72. The test carriage 68 is controlled, e.g., by computer, so that the slider 12 flies on the disk 72 with a desired flying height, and the spindle motor 70 is controlled, e.g., by computer, so that the disk 72 has a desired rotational speed. The position of the slider 12 may be mechanically adjusted in both x and y directions to meet the desired radius similar to the operation of an actual disk drive device.

The probe pins 74 provided in the test fixture 66 are connected to a computer through a print circuit. In particular, one or more control boxes connected with the computer are used to control the slider location to meet the desired testing track. Data is written on the disk through a write sensor of the slider 12 which is controlled by the computer, and data is read on the disk through a read sensor of the slider 12 to determine the track profile. The performance of the slider 12 for both reading and writing can be determined through this test, e.g., the read ampliate, the head overwrite, and stability. Depending on the design requirements of the disk drive device, the dynamic performance testing can easily determine whether the slider 12 is defective or non-defective.

After the dynamic performance testing is completed, the test slider 12 is removed from the test head suspension assembly 10 (step 6 of FIG. 14). If the test slider 12 was determined to be non-defective, then the non-defective slider may be mounted to a head gimbal assembly for use in a disk drive device (steps 7 and 8 of FIG. 14). Alternatively, if the test slider 12 was determined to be defective, then the defective slider is scrapped (steps 7 and 9 of FIG. 14).

As shown in FIG. 13h, the test slider 12 is removed from the test head suspension assembly 10 by first melting or re-flowing, e.g., by a laser 76, the electric connection balls 60 that electrically connect the slider bonding pads 50 and the suspension bonding pads 48. Then, a mechanical vacuum may be used to remove the melted solder material 60. After cooling down, residue solder material 60 may remain on both the suspension bonding pads 48 and the slider bonding pads 50, as shown in FIG. 13i. This residue solder material 60 may act as a pre-bonding material and improve the reliability of the bonding for subsequent bonding processes.

Next, the slider 12 is detached from the top arm 52 of the support structure 16 as shown in FIG. 13j. Specifically, a water cleaning process may be used to remove the water dissolved resin that connects the slider 12 to the top arm 52. In an embodiment, the slider 12 and support structure 16 is dipped in water to remove the water dissolved resin. In another embodiment, ultrasonic may used to increase the detachment speed. This process removes the slider 12 from the support structure 16 while the support structure 16 remains on the suspension 14. As explained above, the slider 12 is then scrapped or mounted to a head gimbal assembly depending on the results of the dynamic performance testing. The test head suspension assembly 10 may then be used to test other sliders.

FIG. 15 illustrates a manufacturing process according to an embodiment of the present invention. After the process starts (step 1001), a HGA suspension is mounted, e.g., by swaging, to a flex cable arm assembly (step 1002) to form a head stack assembly. Then, the HGA suspension is electrically connected, e.g., by bonding, to the flex cable arm assembly (step 1003), and an electric connection and alignment check is performed (step 1004). While this process is being performed, sliders may be tested by the dynamic performance testing described above in FIG. 14.

A non-defective slider is received from the dynamic testing system, and the non-defective slider is attached and electrically bonded to the HGA suspension (step 1005) of the head stack assembly. The head stack assembly is cleaned (step 1006), and the cleaned head stack assembly is assembled to the disk drive device in a drive assembly process (step 1007).

It is noted that the manufacturing process of a disk drive device of FIG. 15 is only exemplary, and a non-defective slider may be incorporated in any suitable manner into a disk drive device having any suitable structure.

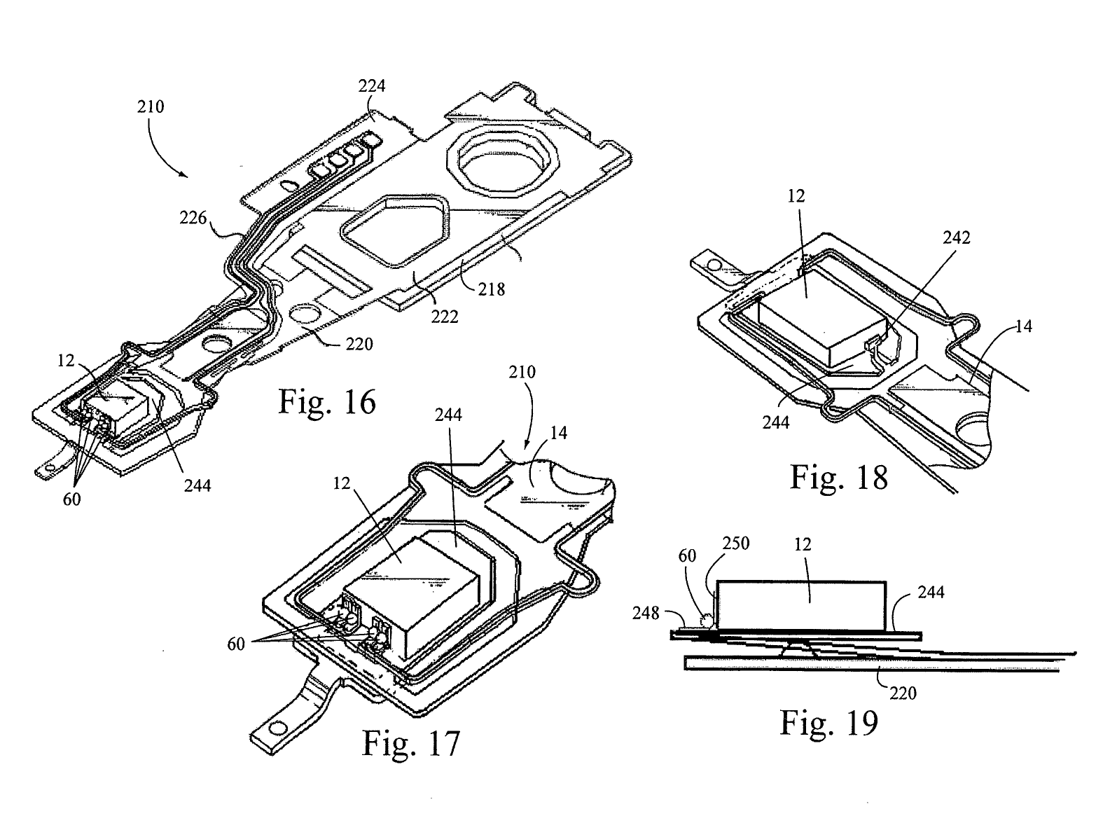

FIGS. 16-19 illustrate a test head suspension assembly 210 according to a second exemplary embodiment of the present invention. The test head suspension assembly 210 may be used in a similar manner as described above to determine whether or not a slider 12 is defective.

In this embodiment, the test head suspension assembly 210 does not include a support structure and the test slider 12 is directly bonded to the suspension 214. Due to the removal of the support structure, the cost of the test head suspension assembly 210 is reduced.

Similar to the above-described embodiment, the test head suspension assembly 210 includes a suspension having a base plate 218, a load beam 220, a hinge 222, a flexure 224, and a suspension trace 226 in the flexure 224. A limiter 242 may be provided on the load beam 220 to limit the movement or deformation of the suspension tongue 244. Also, bonding pads 248 are directly connected to the suspension trace 226 to electrically connect the suspension trace 226 with bonding pads 250 provided on a slider 12 to be tested.

A slider 12 to be tested (with solder pre-bumps 60) is detachably mounted to the suspension tongue 244 of the suspension 214 by a mounting material such as water dissolved resin or adhesive. Then, the bonding pads 248 of the suspension 214 are electrically bonded with respective pads 250 provided on the slider, e.g., by solder reflow. This electrically connects the slider 12 and its read/write elements to the suspension trace 226. The test head suspension assembly 210 may be coupled to the dynamic testing system 64 that does dynamic performance testing on the test slider 12 to determine if the test slider 12 is defective. After the dynamic performance testing is completed, the test slider 12 may be removed from the test head suspension assembly 210 in a manner as described above. Depending on the results of the dynamic performance testing, the slider 12 is scrapped or mounted to a head gimbal assembly.

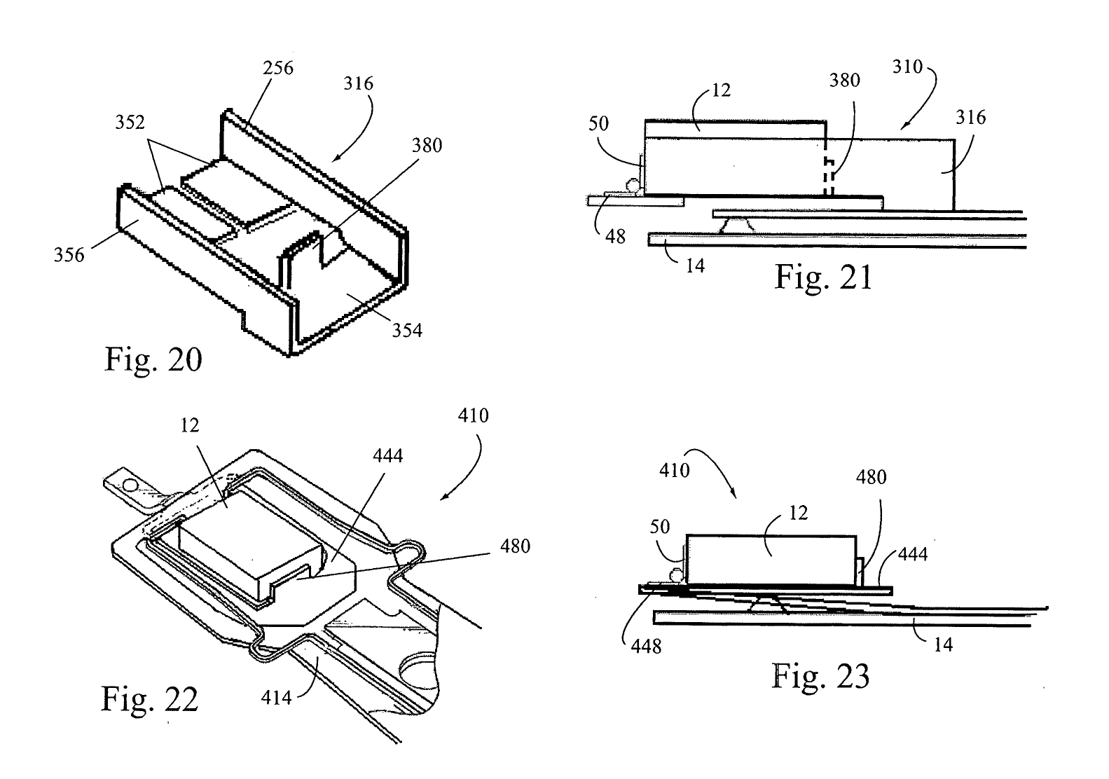

FIGS. 20-21 illustrate a test head suspension assembly 310 according to a third exemplary embodiment of the present invention. The test head suspension assembly 310 may be used in a similar manner as described above to determine whether or not a slider is defective.

In this embodiment, the support structure 316 of the test head suspension assembly 310 includes a vertical beam 380 for slider alignment. Specifically, the support structure 316 includes a top arm 352 separated into two parts, a bottom arm 354 including the vertical beam 380, and support beams 356 that interconnect the top arm 352 and the bottom arm 354. When the test slider 12 is removably mounted to the top arm 352 of the support structure 316, e.g., by water dissolved epoxy, an end of the test slider 12 can be engaged with the vertical beam 380 to properly align the test slider 12 on the support structure 316 (see FIG. 21). The vertical beam 380 also properly aligns the bonding pads 50 of the slider with respective bonding pads 48 provided on the suspension 14.

FIGS. 22-23 illustrate a test head suspension assembly 410 according to a fourth exemplary embodiment of the present invention. The test head suspension assembly 410 may be used in a similar manner as described above to determine whether or not a slider is defective.

In this embodiment, the test slider 12 is directly bonded to the suspension tongue 444 of the suspension 414. Moreover, the suspension tongue 444 includes a vertical beam 480 for slider alignment. When the test slider 12 is removably mounted to the suspension tongue 444, e.g., by water dissolved epoxy, an end of the test slider 12 can be engaged with the vertical beam 480 to properly align the test slider 12 on the suspension tongue 444. The vertical beam 480 also properly aligns the bonding pads 50 of the slider 12 with respective bonding pads 448 provided on the suspension 414.

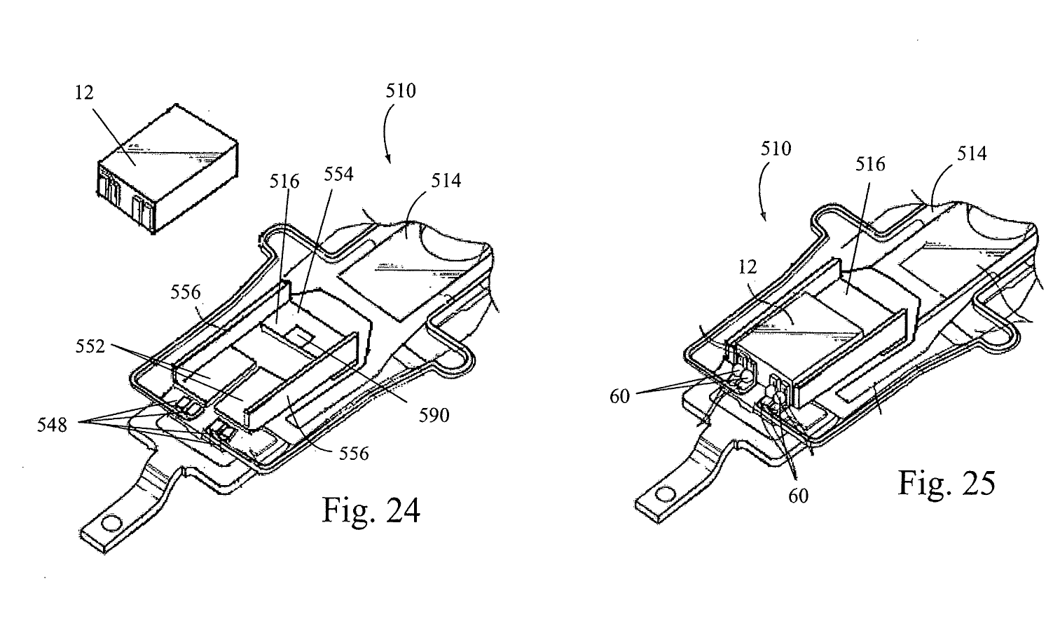

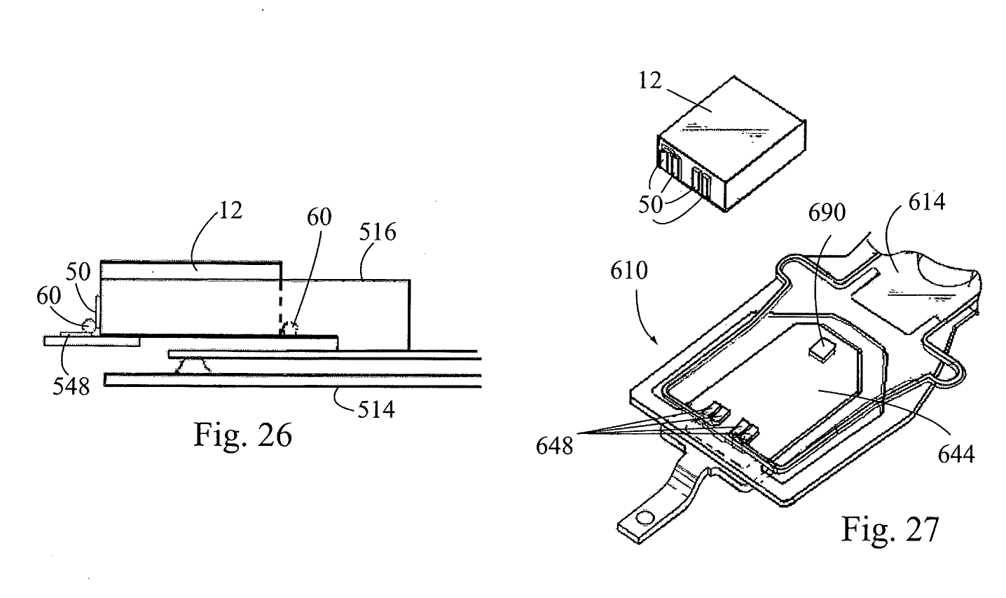

FIGS. 24-26 illustrate a test head suspension assembly 510 according to a fifth exemplary embodiment of the present invention. The test head suspension assembly 510 may be used in a similar manner as described above to determine whether or not a slider is defective.

In this embodiment, the support structure 516 of the test head suspension assembly 510 includes a bonding pad 590 on the bottom arm 554 for use in removably mounting the test slider 12. Specifically, the support structure 516 includes a top arm 552 separated into two parts, a bottom arm 554 including the bonding pad 590, and support beams 556 that interconnect the top arm 552 and the bottom arm 554. When the test slider 12 is removably mounted to the support structure 516, one end of the slider 12 is bonded to the bonding pad 590 on the bottom arm 554, and the opposite end of the slider 12 includes bonding pads 50 that are electrically bonded with respective pads 548 provided on the suspension 514 using, for example, electric connection balls 60 (GBB or SBB). These opposing solder bonds 60 will support the test slider 12 on the support structure 516 as the test slider 12 undergoes dynamic performance testing. After the dynamic performance testing is completed, the test slider 12 may be removed from the support structure 516 by removing the opposing solder bonds 60, e.g., by laser.

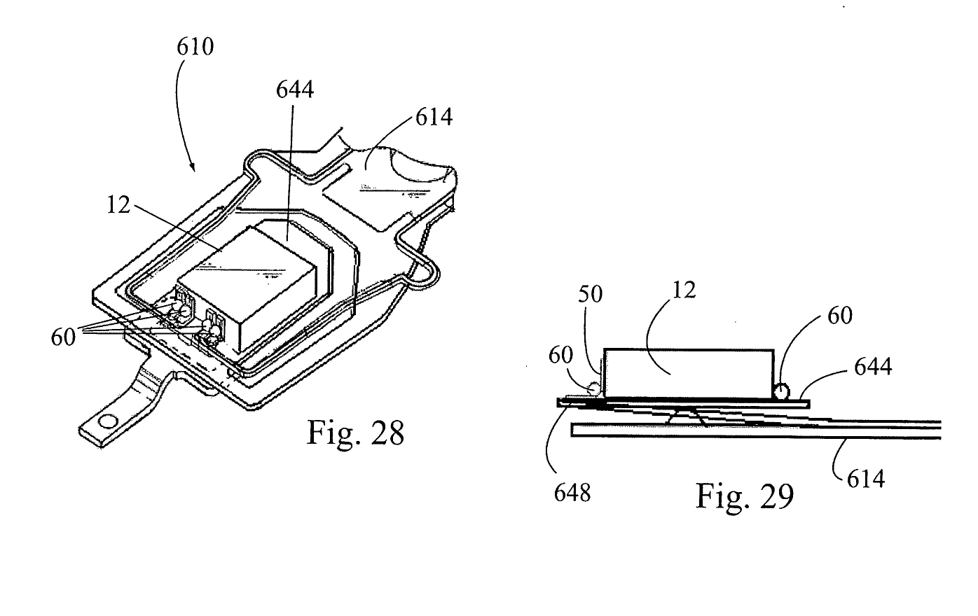

FIGS. 27-29 illustrate a test head suspension assembly 610 according to a sixth exemplary embodiment of the present invention. The test head suspension assembly 610 may be used in a similar manner as described above to determine whether or not a slider is defective.

In this embodiment, the test slider 12 is directly bonded to the suspension tongue 644 of the suspension 614. Moreover, the suspension tongue 644 includes a bonding pad 690 for use in removably mounting the test slider 12. When the test slider 12 is removably mounted to the suspension tongue 644, one end of the slider 12 is bonded to the bonding pad 690 on the suspension tongue 644, and the opposite end of the slider 12 includes bonding pads 50 that are electrically bonded with respective pads 648 provided on the suspension tongue 644 using, for example, electric connection balls 60 (GBB or SBB). These opposing solder bonds 60 will support the test slider 12 on the suspension tongue 644 as the test slider 12 undergoes dynamic performance testing. After the dynamic performance testing is completed, the test slider 12 may be removed from the suspension tongue 644 by removing the opposing solder bonds 60, e.g., by laser.

The exemplary embodiments of the present invention described above provide a testing process to scrap defective sliders before they are mounted to a head gimbal assembly of a disk drive device. This prevents the full HGA from being scrapped if the only the slider is defective. It is also noted that the testing process can be easily incorporated into prior head gimbal assembly manufacturing processes. Further, the testing process may be incorporated into HGAs with or without micro-actuators. Additionally, the testing process allows one to easily mass produce a plurality of non-defective sliders for use in any suitable device with a slider.

Also, in a HGA having a micro-actuator, a parallel gap is provided between the slider and the suspension tongue. Typically, it is difficult to perform dynamic performance testing without the micro-actuator. The support structure described above is provided instead of the micro-actuator, and this structure will keep the test head suspension assembly substantially the same as a micro-actuator HGA. Moreover, the test head suspension assembly provides substantially exact dynamic data of the magnetic slider, so that defective sliders can be scrapped before they are mounted to a head gimbal assembly.

Further, because the slider is tested before it is mounted to a head gimbal assembly, all the dynamic testing in the HGA and HSA level may be cancelled. This reduces the manufacture time, prevents the material scrap rate due to defects caused by slider performance, and prevents rework process to remove defect sliders at the HGA and HSA level. Also, this process helps to prevent handling damage during the manufacture process such as head slider ESD damage and manual damage due to careless handle. Overall, this process improves the process yield, greatly reduces the cost, simplifies the manufacture process for the HSA, and prevents cost input for the investment of equipment or tooling.

Moreover, it is noted that a slider may be used in a variety of different ways. The present invention covers any use of a slider, and is not limited to the specific slider configurations disclosed herein. Also, the methods and systems for testing a slider can be implemented in any suitable disk drive device having a slider or any other device with a slider.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for building a slider into a product, the method comprising:
removably mounting a slider onto a test head suspension assembly; and
conducting a dynamic performance test of the slider before the slider is built into the product.

2. A method for testing the dynamic performance of a slider, the method comprising:
providing a slider to be tested;
removably mounting the slider to a test head suspension assembly;
loading the test head suspension assembly to a dynamic testing system;
testing the dynamic performance of the slider;
detaching the slider from the test head suspension assembly; and
mounting the slider to a HGA based on testing results from the dynamic performance testing of the slider.

3. The method according to claim 2, wherein removably mounting the slider to a test head suspension assembly includes removably mounting the slider to a support structure of the test head suspension assembly.

4. The method according to claim 2, wherein removably mounting the slider to a test head suspension assembly includes removably mounting the slider to a suspension tongue of the test head suspension assembly.

5. The method according to claim 2, wherein mounting the slider to a HGA based on testing results includes scrapping the slider before the slider is mounted to the HGA if the slider is defective based on testing results.

6. The method according to claim 2, wherein mounting the slider to a HGA based on testing results includes mounting the slider to the HGA if the slider is not defective based on testing results.

7. The method according to claim 2, wherein removably mounting the slider to a test head suspension assembly includes using solder bonding.

8. The method according to claim 2, wherein detaching the slider from the test head suspension assembly includes laser cure or re-flow process.

9. The method according to claim 2, wherein testing the dynamic performance of the slider includes moving the test head suspension assembly so that the slider flies on a desired track of a spindle disk and writing and reading data on the spindle disk by the slider to detect the read/write performance and stability of the slider.

10. The method according to claim 2, wherein removably mounting the slider to a test head suspension assembly includes physically and electrically mounting the slider to a test head suspension assembly.

11. The method according to claim 2, wherein loading the test head suspension assembly to a dynamic testing system includes electrically connecting read/write elements of the slider to the dynamic testing system.

12. A test head suspension assembly for testing the dynamic performance of a slider, the test head suspension assembly comprising:
a suspension; and
a support structure connected to the suspension, the support structure being structured to removably support a slider to be tested on the suspension.

13. The test head suspension assembly according to claim 12, wherein the support structure is made of metal.

14. The test head suspension assembly according to claim 12, wherein the support structure includes a top arm that removably supports the slider to be tested, a bottom that connects the support structure to the suspension, and support beams that interconnect the top arm and the bottom arm.

15. The test head suspension assembly according to claim 14, wherein one of the top arm and the bottom arm is separated into two parts.

16. The test head suspension assembly according to claim 12, wherein the suspension includes a base plate, a load beam with a dimple, a hinge coupled with the base plate and the load beam by welding, and a flexure with multiple traces welded with the hinge and the load beam.

17. The test head suspension assembly according to claim 16, wherein the flexure includes bonding pads to electrically connect the slider to the suspension by solder ball bonding.

18. The test head suspension assembly according to claim 17, wherein the slider is electrically detached from the suspension by solder ball re-flow.

19. The test head suspension assembly according to claim 16, wherein the flexure includes bonding pads to electrically connect the suspension to a dynamic testing system.

20. The test head suspension assembly according to claim 12, wherein the support structure is physically coupled to the slider by water dissolved epoxy.

21. The test head suspension assembly according to claim 20, wherein the slider is physically detached from the support structure by cleaning or dipping.
